(19) United States
(12) Patent Application Publication
(10) Pub. No.: US 2008/0240900 A1
(43) Pub. Date: Oct. 2, 2008

(54) System for storage and retrieval

(76) Inventor: Eric Reisenauer, Owego, NY (US)

Correspondence Address: MICHAEL BEST & FRIEDRICH LLP, 100 E WISCONSIN AVENUE, Suite 3300, MILWAUKEE, WI, 53202, US

(21) Appl. No.: 11/729,691

(22) Filed: Mar. 29, 2007

(51) Int. Cl. B65G 49/00

(52) U.S. Cl. 414/798.5; 414/137.1

(57) ABSTRACT

A storage and retrieval system that includes a carrier and a drive member. The carrier includes a guide member rotatable with respect to a support surface from a first position to a second position such that the carrier is movable in a first direction when the guide member is in the first position and the carrier is movable in a second direction when the carrier is in the second position. The drive member includes a portion coupled to the guide member. The portion of the drive member is selectively rotatable from a first orientation to a second orientation such that the drive member is configured to move the carrier in the first direction when the portion of the drive member is in the first orientation, and the drive member is configured to move the carrier in the second direction when the portion of the drive member is in the second orientation.

### BACKGROUND

The present invention relates to storage and retrieval systems.

Storage and retrieval systems can be used in warehouses, factories, and marine vessels to store a product and then, at a later time, retrieve the product. Such systems typically include a carrier that supports the product. The carrier is often utilized to move the product between a loading location, a storage location, and a retrieval location. For example, the product can be loaded onto the carrier at the loading location. Then, the carrier can transport the product to a storage location where the product is stored until a worker desires to retrieve the product. The carrier can then transport the product to an unloading location where the worker retrieves the product. Often, the storage and retrieval system is arranged in a matrix configuration to facilitate tracking the location of the products.

The carrier often includes an on-board drive member to transport the carrier and the product. Carriers with on-board drive members are usually complex and include an on-board power supply, such as batteries, that can add to the cost and maintenance of the carrier. Additional drive components of such carriers, which can include gears, also add to the complexity and cost of the carrier.

### SUMMARY

The storage and retrieval system embodying the present invention provides a system where the drive members are independent from the carriers (i.e., the drive members are not on-board drive members that move with the carriers). Rather, the drive members form a portion of base units of the storage and retrieval system that are held fixed with respect to a floor that supports the base units and the storage and retrieval system.

In one embodiment, the invention provides a storage and retrieval system that includes a carrier and a drive member. The carrier defines a support surface configured to support a product stored by the storage and retrieval system. The carrier includes a guide member rotatable with respect to the support surface from a first position to a second position such that the carrier is movable in a first direction when the guide member is in the first position and the carrier is movable in a second direction when the carrier is in the second position. The drive member includes a portion coupled to the guide member. The portion of the drive member is selectively rotatable from a first orientation to a second orientation such that the drive member is configured to move the carrier in the first direction when the portion of the drive member is in the first orientation, and the drive member is configured to move the carrier in the second direction when the portion of the drive member is in the second orientation.

In another embodiment, the invention provides a storage and retrieval system that includes a carrier, a first base unit, a second base unit, and a third base unit. The carrier defines a support surface configured to support a product stored by the storage and retrieval system. The carrier includes a guide member configured to be rotated with respect to the support surface from a first position to a second position such that the carrier is configured to be moved in a first direction when the guide member is in the first position and the carrier is configured to be moved in a second direction when the guide member is in the second position. The first base unit includes a first track, the second base unit includes a second track, and the third base unit includes a third track. The second track is configured to be rotated from a first orientation where the second track is aligned with the first track such that the carrier is movable in the first direction from the second base unit to the first base unit, and the second track is configured to be rotated from a second orientation where the second track is aligned with the third track such that the carrier is movable in the second direction from the second base unit to the third base unit.

Other aspects of the invention will become apparent by consideration of the detailed description and accompanying drawings.

### BRIEF DESCRIPTION OF THE DRAWINGS

FIG. 1 is a perspective view illustrating a storage and retrieval system embodying the present invention.

FIG. 2 is a perspective view of the storage and retrieval system of FIG. 1 illustrating a carrier moved from the position illustrated in FIG. 1.

FIG. 3 is a perspective view of a base unit of the storage and retrieval system of FIG. 1 illustrating a drive member in a first orientation.

FIG. 4 is a perspective view of the base unit of the storage and retrieval system of FIG. 1 illustrating the drive member in a second orientation.

FIG. 5 is a cross-sectional view of the base unit of the storage and retrieval system of FIG. 1 taken along line 5-5 of FIG. 3 with cross-hatching removed for clarity.

FIG. 6 is a perspective view of the bottom of a carrier of the storage and retrieval system of FIG. 1.

FIG. 7 is an enlarged view of a portion of the bottom of the carrier of the storage and retrieval system of FIG. 1 illustrating a locking member of the carrier in a locked position.

FIG. 8 is an end view of the base unit and the carrier of the storage and retrieval system of FIG. 1 with the drive member of the base unit in the first orientation.

FIG. 9 is a cross-sectional view of an unlocking member of the base unit and the locking member of the carrier of FIG. 1 illustrating the locking member in a locked position and the unlocking member in a first position or lowered position.

FIG. 10 is a cross-sectional view of the unlocking member of the base unit and the locking member of the carrier of FIG. 1 illustrating the locking member between the locked position and an unlocked position and the unlocking member of the base unit between the lowered position and a raised position.

FIG. 11 is a cross-sectional view of the unlocking member of the base unit and the locking member of the carrier of FIG. 1 illustrating the locking member in the unlocked position and the unlocking member in the raised position.

FIG. 12 is a schematic illustration of an alternative arrangement of the storage and retrieval system of FIG. 1.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

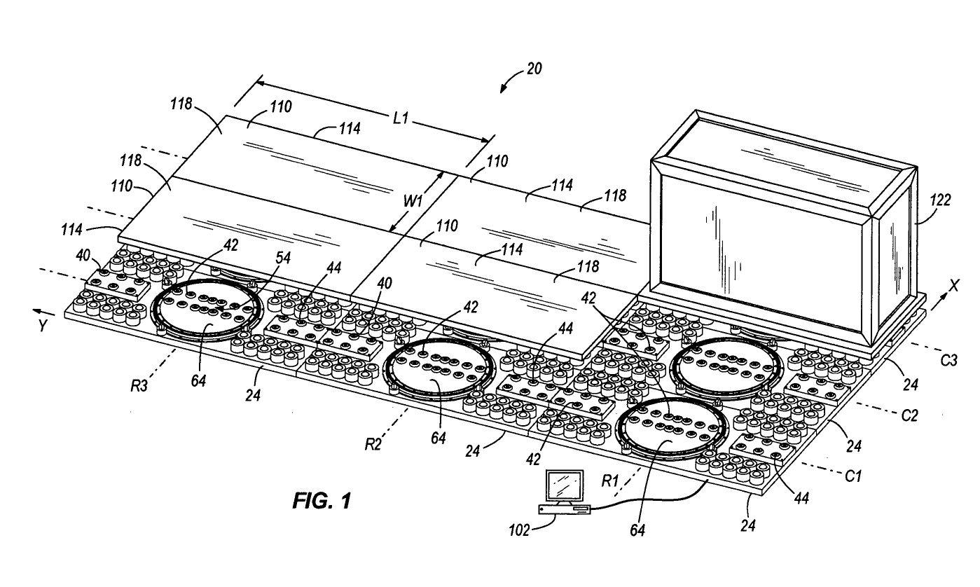

FIG. 1 illustrates a storage and retrieval system 20. The storage and retrieval system 20 creates a movable floor system that is configured to store and transport products. In one application, the storage and retrieval system 20 creates a movable floor system that is configured to store and transport products on a marine vessel. In other applications, the storage and retrieval system 20 can be utilized in warehouses, factories, storage rooms, etc.

With continued reference to FIG. 1, the storage and retrieval system 20 includes cells or base units 24 that are arranged along an x-axis and a y-axis to define a matrix having rows R1, R2, R3 and columns C1, C2, C3. While FIG. 1 illustrates nine base units 24 arranged in a three-by-three matrix, it should be understood that the storage and retrieval system 20 can include any suitable number of units 24 arranged to define any suitably sized or configured matrix.

Each of the base units 24 is substantially the same, and therefore, only one of the units 24 will be described in detail below and like components have been given like references numbers.

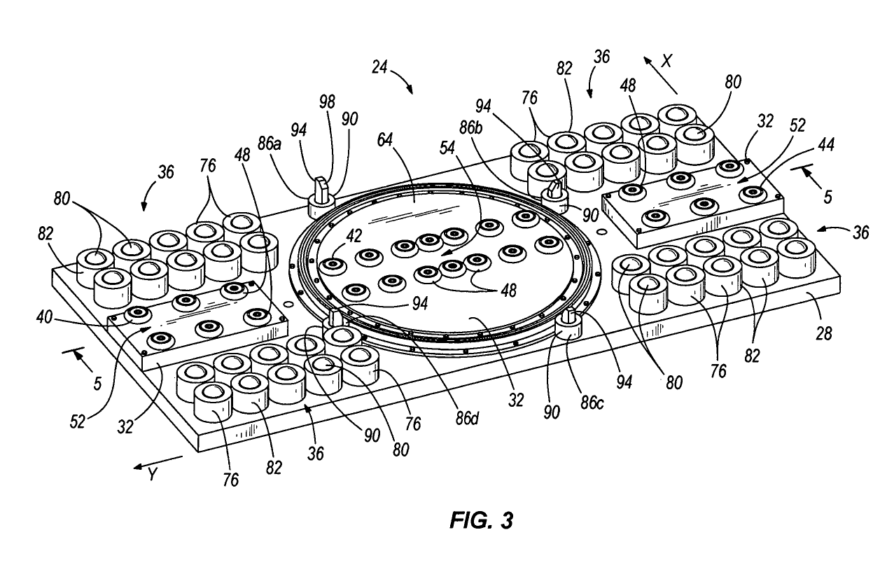

Referring to FIG. 3, the illustrated base unit 24 of the storage and retrieval system 20 includes a housing 28, a drive assembly 32, and friction reduction members 36. The housing 28 of the base unit 24 is coupled to and fixed with respect to a floor that supports the storage and retrieval system, which can include the floor of a marine vessel, warehouse, storage room, and the like.

The illustrated drive assembly 32 is a friction drive that includes a first track 40, a second track 42, and a third track 44. Each of the tracks 40, 42, and 44 is formed from a plurality of rollers 48. The rollers 48 of the tracks 40 and 44 are arranged such that each of the tracks 40 and 44 defines an elongated gap 52, and the rollers 48 of the track 42 are arranged to define an elongated gap 54. The rollers 48 can be formed from any suitable material, and in one construction, the rollers 48 are formed from a high friction material, such as urethane.

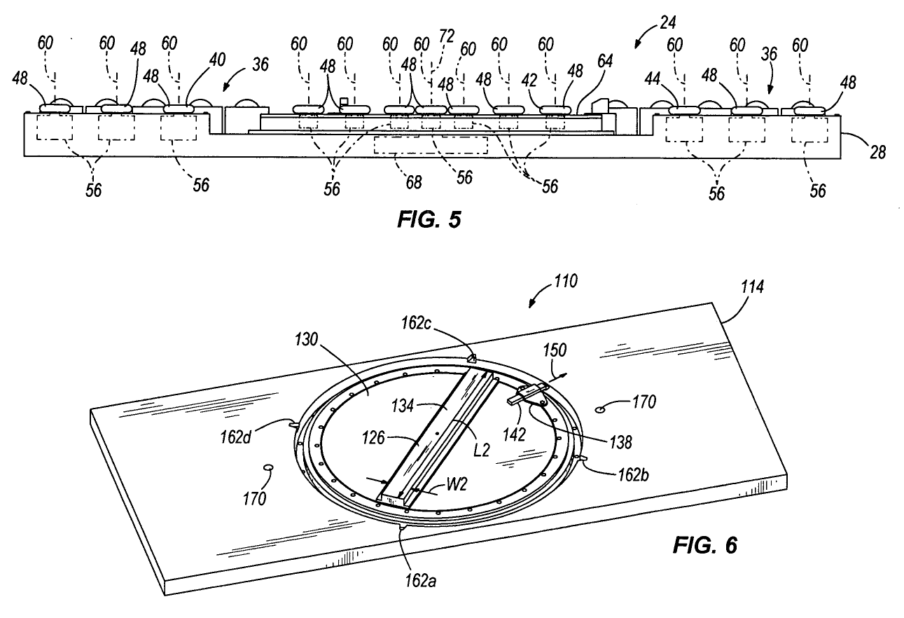

Referring to FIG. 5, a drive member 56 is coupled to each of the rollers 48. The drive members 56 drive or rotate the corresponding roller 48 about an axis 60. While in the illustrated construction, a drive member 56 is coupled to each of the rollers 48, in other constructions, a drive member may be coupled to only some of the rollers 48. For example, in other constructions, any suitable number of the rollers 48 can be driven and any suitable number of the rollers 48 can free wheel or freely rotate without being driven. The drive members 56 can include any suitable member such as a gear, pulley, etc. that is coupled to a belt, chain, and the like, which can be driven by a motor and the like, to rotate the drive members 56, and therefore, the rollers 48. In yet other constructions, the drive member 56 can include an electric motor that directly rotates and drives the rollers 48.

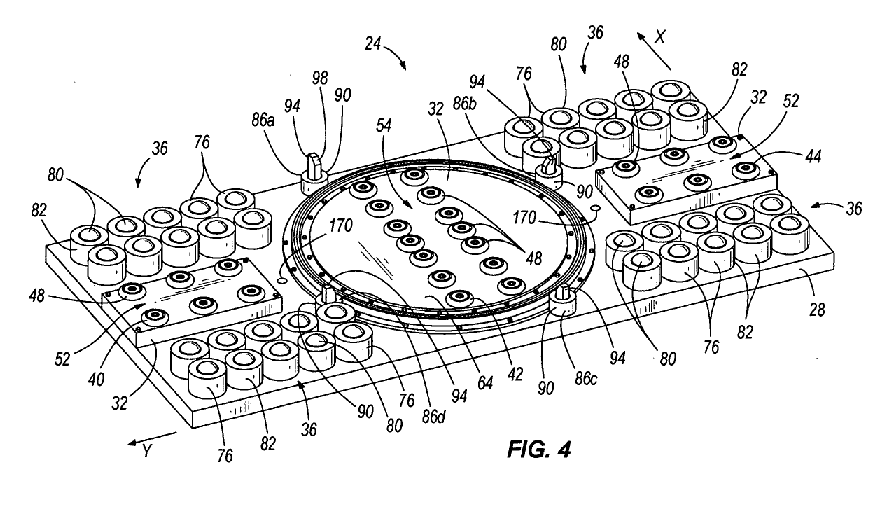

Referring to FIGS. 3 and 4, the second track 42 is coupled to a turntable 64 such that the second track 40 is movable with respect to the housing 28 of the base unit 24. The turntable 64 can be mounted to the housing 28 using a bearing, a low friction surface, and the like to facilitate rotation of the turntable 64 with respect to the housing 28. As illustrated in FIG. 5, a turntable drive member 68, such as a gear, pulley, electric motor, including a stepper motor, and the like, can be utilized to rotate the turntable 64 and the track 42 about an axis 72. In the illustrated construction, the turntable 64 and the track 42 are rotatable 360 degrees about the axis 72.

Referring to FIGS. 3, 4, and 5, the turntable drive member 68 (FIG. 5) is utilized to rotate the track 42 between a first orientation (FIG. 3) and a second orientation (FIG. 4). In the first orientation (FIG. 3), the track 42 is positioned such that the elongated gap 54 of the track 42 is parallel with the y-axis of the storage and retrieval system 20. In the second orientation (FIG. 4), the track 42 is positioned such that the elongated gap 54 is parallel with the x-axis of the storage and retrieval system 20. Also, in the second orientation, the elongated gap 54 of the track 42 is aligned with the elongated gaps 52 of the first and third track members 40 and 44, which are fixed from rotating with respect to the base unit 24. In the illustrated construction, the first and second orientations of the track 42 are approximately 90 degrees apart. In other constructions, the first and second orientations can be spaced more or less than 90 degrees.

Referring to FIG. 3, in the illustrated construction, the friction reduction members 36 include a plurality of ball transfer units 76. As would be understood by one of skill in the art, the ball transfer units 76 each include a ball 80 received in a socket defined by a base 82. The ball 80 is received by the base 82, which is fixed with respect the housing 28, such that the ball 80 can rotate in any direction while being retained by the base 82. In other constructions, the friction reduction members 36 can include other suitable members, such as sheets of ultra-high molecular weight (UHMW) polyethylene and the like.

With continued reference to FIG. 3, the base unit 24 further includes shot pins or unlocking members 86a, 86b, 86c, and 86d located around the perimeter of the turntable 64. Each of the locking member 86a-86d includes a base 90 that is coupled to and fixed with respect to the housing 28 of the base unit 24 and a pin 94 that is extendable from the base 90. The pins 94 each include an angled cam surface 98 (see FIG. 9). The pins 94 are extendable from the respective bases 90. FIG. 3 illustrates the pin 94 of the unlocking member 86a extended from the base 90 in a raised position, while the pins 94 of the unlocking members 86b, 86c, and 86d are in a lowered position. The pins 94 of the unlocking members 86a-86d are selectively movable between the raised and lowered positions using any suitable device, such as a piston, solenoid, and the like.

Referring to FIG. 1, the storage and retrieval system 20 further includes a controller 102. The controller 102 can be any suitable controller, such as a computer, programmable logic controller (PLC), and the like. The controller 102 can be utilized to control the operation of the base units 24 and the storage and retrieval system 20. For example, referring to FIGS. 1 and 3, the controller 102 can be utilized to turn the drive assembly 32 ‘on’ and ‘off’ such that the rollers 48 of the drive assembly 32 are driven when the drive assembly 32 is ‘on’ and the rollers 48 are not driven when the drive assembly 32 is ‘off.’ In addition, the controller 102 can be utilized to rotate the turntable 64 and track 42 of the base units 24 and to control the position (i.e., raised or lowered) of the unlocking members 86a-86d.

With continued reference to FIG. 1, the storage and retrieval system 20 further includes carriers 110. Each of the carriers 110 is substantially the same, and therefore, only one carrier 110 will be described in detail below and like components have been given like reference numbers.

Referring to FIGS. 1 and 6, the carrier 110 includes a carrier plate 114 that defines a support surface 118. The support surface 118 supports products stored by the storage and retrieval system 20. In the illustrated construction, the products are stored in a crate 122. In other constructions, the support surface 118 can support standard pallets, skids, boxes, other forms of crates, and the like that are utilized to store the products.

As best seen in FIG. 1, the carrier plate 114 defines a length L1 and a width W1. In one construction, the length L1 is approximately 48 inches and the width W1 is approximately 40 inches, which, as would be understood by one of skill in the art, corresponds to the dimensions of a standard pallet or skid. In other constructions, the length L1 and the width W1 can be multiples of the standard pallet (i.e., a width W1 of approximately 80 inches, 120 inches, etc., and/or a length L1 of approximately 96 inches, 144 inches, etc.) In yet other constructions, the carrier plate can have any suitable length L1 and width W1 and can be scaled to any suitable dimension for the particular application of the storage and retrieval system.

Referring to FIGS. 1 and 6, the carrier 110 further includes a traction rib or guide member 126 located on an underside of the carrier 114 opposite the support surface 118. In the illustrated construction, the guide member 126 is an elongated member that extends from the underside of the carrier plate 114. Referring to FIG. 6, the guide member 126 is interconnected with the carrier plate 114 by a turntable 130. A bearing, low friction surface, or the like is utilized to couple the turntable 130 to the carrier plate 114 such that the turntable 130 is rotatable about an axis 134 with respect to the carrier plate 114. The guide member 126 is fixed to the turntable 130 such that the guide member rotates 126 with the turntable 130 about the axis 134 with respect to the carrier plate 114.

Referring to FIGS. 3, 6 and 8, the guide member 126 defines a length L2 and a width W2. The width W2 is sized so that the guide member 126 is received in the elongated gaps 52 of the tracks 40 and 44 and the elongated gap 54 of the track 42 such that there is an interference fit between the rollers 48 and the guide member 126. Accordingly, the rollers 48 contact the guide member 126, as illustrated in FIG. 8. The length L2 of the guide member 126 is about equal to or less than the length of the track 42 so that the guide member 126 can rotate with the track 42 without being restricted by the unlocking members 86a-86d.

With continued reference to FIG. 8, the carrier 110 is received by the base unit 24 such that the carrier plate 114 is directly supported by the balls 80 of the ball transfer units 76. Accordingly, the weight of the carrier 110 and the weight of products supported by the carrier 110 are distributed among the ball transfer units 76. By supporting the weight of the carrier 110 by the ball transfer units 76, the carrier 110 is able to move in the x and y directions (see FIG. 3) with respect to the base unit 24.

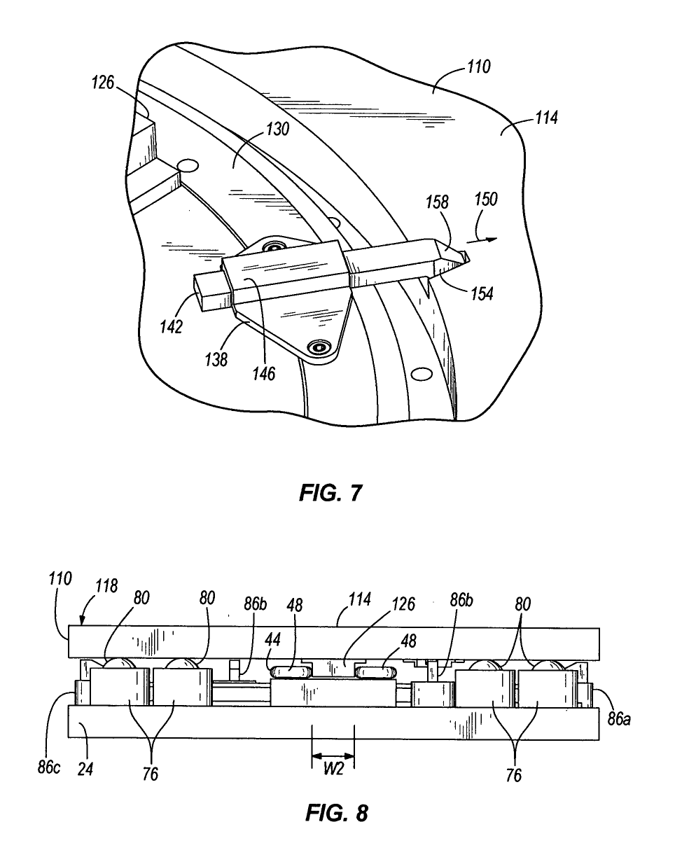

Referring to FIGS. 6 and 7, the carrier 110 further includes a locking member 138. The locking member 138 is coupled to the turntable 130 such that the locking member 138 rotates with the turntable 130 relative to the carrier plate 114. The locking member 138 includes a pin 142, a housing 146, and a spring located within the housing 146 that biases the pin 142 outwardly or in the direction of arrow 150 of FIGS. 6 and 7. The pin 142 includes a generally V-shaped or tapered head portion 154. The head portion 154 further includes a tapered cam surface 158.

With continued reference to FIGS. 6 and 7, the carrier 110 further includes V-shaped or tapered recesses 162a, 162b, 162c, and 162d. The recesses 162a-162d and the head portion 154 of the pin 142 are V-shaped or tapered to facilitate insertion and removal of the pin 142 from the recesses 162a-162d. The recesses 162a-162d are located around the perimeter of the turntable 130 such that the pin 142 of the locking member 138 can be received in the recesses 162a-162d as illustrated in FIG. 7. Furthermore, the recesses 162a-162d are located such that when the carrier 110 is in a home position, as illustrated in FIG. 1, with respect to one of the base units 24, the recesses 162a-162d are aligned with the pins 94 of respective unlocking members 86a-86d. Therefore, referring to FIGS. 3 and 6, the pin 94 of the unlocking member 86a is aligned with the recess 162a, the pin 94 of the unlocking member 86b is aligned with the recess 162b, etc. The pins 94 and the recesses 162a-162d are aligned such that the respective pin 94 can be received by the respective recess 162a-162d as illustrated in FIG. 11.

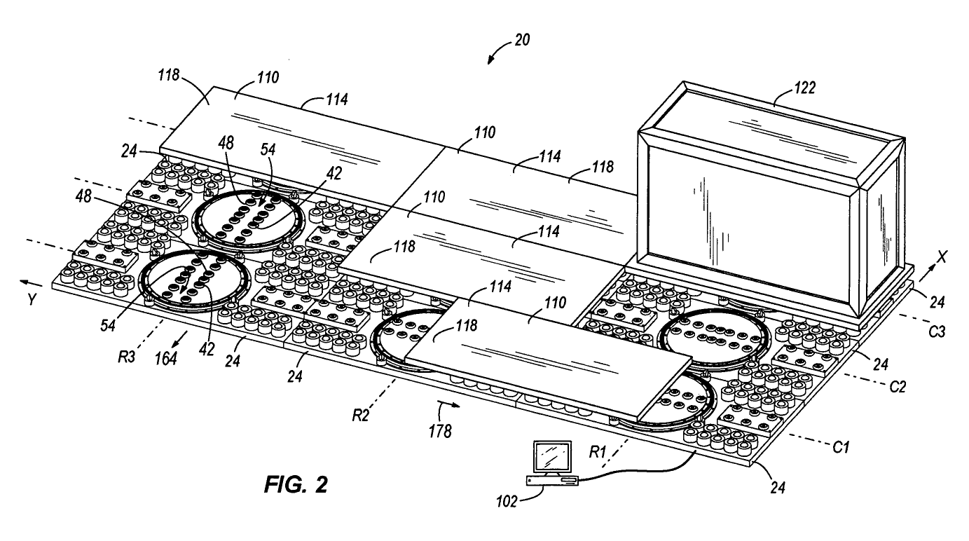

Referring to FIGS. 1 and 2, the storage and retrieval system 20 is operable to move the carriers 110 between the cells or base units 24. For example, referring to FIG. 1, the carrier 110 located at the unit 24 at column C2, row R3 is movable to any open unit 24 (i.e., a unit that does not have a carrier 110 positioned over the track members 40, 42, and 44), such as the unit 24 located at column C1, row R1 in the illustrated construction.

Referring to FIGS. 1 and 4, to move the carrier 110 located at column C2, row R3 in FIG. 1 in the x-direction to column C1, row R3, the tracks 42 of the base units 24 at column C2, row R3 and column C1, row R3 are rotated to the second orientation (see FIGS. 2 and 4) such that the elongated gaps 54 of the tracks 42 are parallel to the x-axis. Therefore, as visible in FIG. 2, the elongated gaps 54 of the tracks 42 of the units 24 at column C2, row R3 and column C1, row R3 are aligned. With the tracks 42 aligned, the rollers 48 of the tracks 42 at column C2, row R3 and column C1, row R3 are driven to move the carrier 110 from the unit 24 at column C2, row R3 in the x-direction (indicated by arrow 164 of FIG. 2) to the unit 24 at column C1, row R3. Because the guide member 126 (FIGS. 6 and 8) is received between the rollers 48 of the track 42, friction between the guide member 126 and the rollers 48 pushes or pulls the guide member 126, and therefore, the carrier 110.

Referring to FIGS. 2 and 6, the carrier 110 moves in the x-direction until the carrier 110 is properly positioned (i.e, in the home position) with respect to the unit 24 at column C1, row R3. When the carrier 110 is properly positioned at column C1, row R3, the rollers 48 of the track 42 at column C1, row R3 can be deactivated, and therefore, the rollers 48 no longer move the carrier 110. The carrier 110 is properly positioned with respect the unit 24 when the guide member 126 of the carrier 110 is located entirely within the track 42 (i.e., the guide member 126 does not extend past ends of track 42). Position sensors 170 and the like can be utilized to determine when the carrier 110 is properly positioned with respect to the unit 24. For example, referring to FIGS. 4 and 6, the carrier 110 and the unit 24 may include respective position sensors 170 that are substantially aligned to determine when the carriers 110 are properly positioned with respect to the units 24 as illustrated in FIG. 1.

After the carrier 110 is properly positioned with respect to the unit 24 at column C1, row R3, the rotatable track 42 of the unit 24 at column C1, row R3 is rotated from the second orientation (FIG. 4) to the first orientation (FIG. 1) using the turntable drive member 68 (FIG. 5).

Referring to FIGS. 1 and 6, when the carrier 110 moves in the x-direction, the pin 142 of the turntable locking member 138 is received in either the recess 162a or 162c such that the guide member 126 extends lengthwise in the x-direction. With the pin 142 in the locked position or received in either the recess 162a or 162c the guide member 126 is retained from rotation with respect to the carrier plate 114.

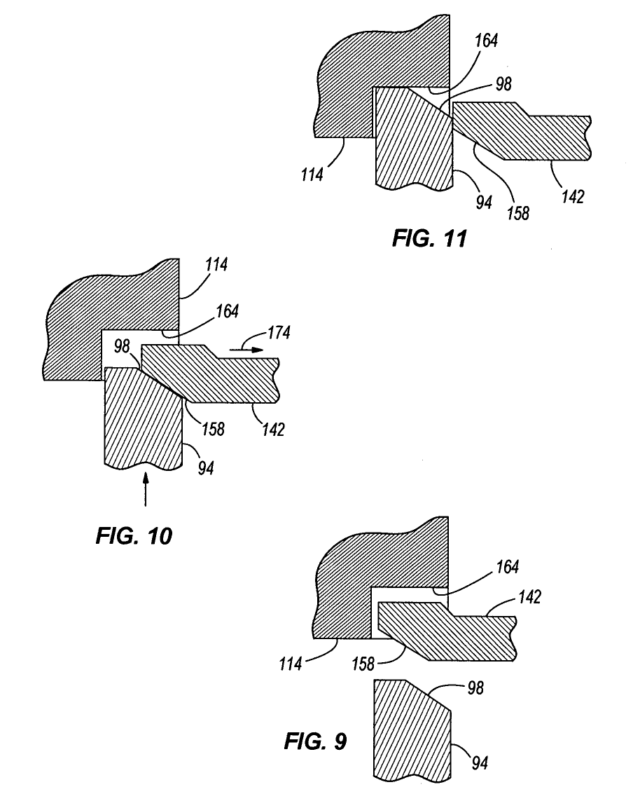

Referring to FIGS. 4, 6, and 7, to disengage the pin 142 from the recess 162a or 162c, the pin 94 of the corresponding unlocking member 86a or 86c is moved to the extended position. Referring to FIGS. 9-11, as the pin 94 moves from the lowered position (FIG. 9) to the raised position (FIG. 11), the cam surface 98 of the pin 94 contacts the cam surface 158 of the pin 142 to move the pin 142 in the direction of arrow 174 of FIG. 10 to move the pin 142 toward the unlocked position. As illustrated in FIG. 11, when the pin 94 is in the raised position, the pin 94 is located in the respective recess 162 and the pin 142 is in the unlocked position such that the pin 142 is not received in the recess 162. As illustrated in FIG. 6, with the pin 142 in the unlocked position, the guide member 126 and turntable 130 are able to rotate with respect to the carrier plate 114. Therefore, referring to FIGS. 1 and 2, the rotatable track 42 of the unit 24 at column C1, row R3 is rotated from the second orientation (FIG. 2) to the first orientation (FIG. 1) to rotate the guide member 126 of the carrier 110 such that the guide member 126 extends lengthwise, parallel to the y-axis.

Referring to FIGS. 1 and 6, when the track 42 of the unit 24 at column C1, row R3 rotates into the first orientation, the guide member 126 is also rotated such that the pin 142 of the turntable locking member 138 is aligned with either the recess 162b or 162d. With the pin 142 aligned with one of the recesses 162b or 162d, the spring of the locking member 138 moves the pin 142 to the locked position and the pin 142 is received in either the recess 162b or 162d. Therefore, the guide member 126 is retained from rotation with respect to the carrier plate 114 and the guide member 126 is aligned lengthwise, parallel to the y-axis. Referring to FIGS. 3, 6 and 11, also, when the guide member 126 is rotated by the track 42, some of the pins 94 of the unlocking members 86a-86d can be placed in the extended position (FIG. 11) to inhibit the pin 142 from being received in the respective recesses 162a-162d. For example, if it is desired to place the guide member 126 parallel to the y-axis, the pins 86a and 86c can be placed in the extended position and thus received in the recesses 162a and 162c, respectively. Therefore, if the pin 142 is rotated past the recesses 162a and 162c, the pin 142 will not enter the recesses 162a or 162c. Rather, the pin 142 will extend into the next open recesses 162b or 162d to align the guide member 126 parallel to the y-axis.

As illustrated in FIG. 1, the rotatable track 42 of the adjacent unit 24, located at column C1, row R2, is also placed in the first orientation such that the track 42 of the unit 24 at column C1, row R2 is aligned with the track 42 of the unit 24 at column C1, row R3.

With the tracks 42 of the units 24 of column C1 in the first orientation, the rollers 48 of the tracks 40, 42, and 44 of the units 24 of column C1 are activated or driven to pull or push the guide member 126, and therefore the carrier 110, to move the carrier 110 in the y-direction as indicated by the arrow 178 of FIG. 2.

Referring to FIGS. 1, 3, 6, and 11, when the carrier 110 is in the home position with respect to the base unit 24, the pins 94 of the unlocking members 86a-86d can be utilized to secure the location of the carrier 110 with respect to the base unit 24. One or more of the pins 94 can be moved to the extended position, such as the pin 94 of the locking member 86a of FIG. 3, such that the pins 94 are received in the respective recesses 162a-162d as illustrated in FIG. 11. With the pins 94 received in the respective recesses 162a-162d, the pins 94 secure the location of the carrier 110 to restrict movement of the carrier in either the x-direction or the y-direction.

While the foregoing description describes movement of just one carrier 110 of the storage and retrieval system 20, a substantially similar method can be utilized to move any of the carriers 110 of the storage and retrieval system 20 of FIG. 1 in the x-direction or the y-direction to any of the units 24.

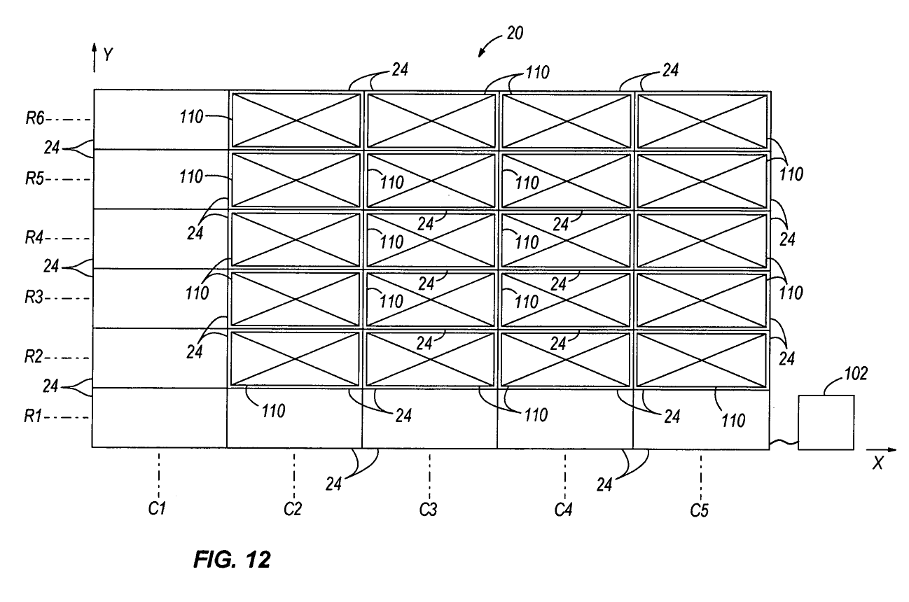

For example, FIG. 12 schematically illustrates an alternative arrangement of the storage and retrieval system 20 of FIGS. 1 and 2. Representative components illustrated in FIG. 12 have been given the same reference number as the component they represent in FIGS. 1-11.

In the arrangement illustrated in FIG. 12, the storage and retrieval system 20 includes five columns (C1-C5) and six rows (R1-R6) such that the units 24 define a five-by-six matrix having a total of thirty units 24. Of course, other suitable arrangements of the units 24 can be utilized. The illustrated arrangement of the storage and retrieval system 20 also includes twenty carriers 110. The carriers 110 are arranged such that the units 24 that define column C1 and the units 24 that define row R1 do not include a respective carrier 110. Row R1 and column C1 are known as a pick lane or transfer lane.

The carrier 110 located at column C2, row R6 can be moved in the x-direction, as discussed above, into column C1 and then moved in the y-direction to row R1, as discussed above. Additionally, the carrier 110 could be moved in the x-direction in row R1 to any of the columns C1 through C5. Similarly, any of the carriers 110 illustrated in FIG. 12 can be moved to any one of the units 24 in columns C1-C5 and rows R1-R5 by appropriately moving adjacent carriers 110 in either the x-direction or the y-direction.

With continued reference to FIG. 12, the controller 102 can also be used to inventory and track the product stored by the carriers 110. Therefore, a product can be loaded onto a carrier 110 and the location (i.e., column and row) can be tracked. Thus, when the user desires to retrieve the products from the storage and retrieval system 20, the user requests the product using the controller 102 and the controller 102 will automatically control the storage and retrieval system 20 to move the appropriate carrier 110 with the desired product to the location desired by the user, which can includes any one of the units 24 located at columns C1-C5 and rows R1-R6.

Various features and advantages of the invention are set forth in the following claims.

What is claimed is:

1. A storage and retrieval system comprising:
a carrier defining a support surface configured to support a product stored by the storage and retrieval system, the carrier including a guide member rotatable with respect to the support surface from a first position to a second position such that the carrier is movable in a first direction when the guide member is in the first position and the carrier is movable in a second direction when the carrier is in the second position; and
a drive member having a portion coupled to the guide member, the portion of the drive member being configured to be selectively rotatable from a first orientation to a second orientation such that the drive member is configured to move the carrier in the first direction when the portion of the drive member is in the first orientation, and the drive member is configured to move the carrier in the second direction when the portion of the drive member is in the second orientation.

2. The storage and retrieval system of claim 1, wherein the carrier is configured to move relative to the drive member.

3. The storage and retrieval system of claim 1, wherein the drive member includes a friction drive, and wherein the guide member is configured to be received by the friction drive.

4. The storage and retrieval system of claim 3, wherein the friction drive includes a plurality of rollers, and wherein at least one of the plurality of rollers is configured to be driven to thereby move the carrier in the first and second directions.

5. The storage and retrieval system of claim 1, wherein the carrier includes a locking member, wherein the locking member is configured to be moved between a locked position and an unlocked position such that the locking member retains the guide member in one of the first and second positions when the locking member is in the locked position, and wherein the guide member is configured to rotate with respect to the support surface when the locking member is in the unlocked position.

6. The storage and retrieval system of claim 5, wherein the carrier further includes a first recess and a second recess, wherein the locking member includes a pin member configured to be received in the first recess when the locking member is in the locked position to retain the guide member in the first position, and wherein the locking member is configured to be received in the second recess when the locking member is in the locked position to retain the guide member in the second position.

7. The storage and retrieval system of claim 6, further comprising a base unit including an unlocking member, the unlocking member configured to be extended from the base unit from a first unlocking member position to a second unlocking member position to move the pin from the locked position to the unlocked position.

8. The storage and retrieval system of claim 7, wherein the base unit is configured to be generally fixed with respect to a floor that supports the base unit, and wherein when the unlocking member of the base unit is in the second position at least a portion of the unlocking member is configured to be received in one of the first and second recesses of the carrier to fix the location of the carrier with respect to the base unit.

9. The storage and retrieval system of claim 1, further comprising a base unit configured to be fixed with respect to a floor that supports the base unit, the carrier configured to be moved with respect to the base unit, and wherein the base unit includes a plurality of ball transfer units configured to facilitate movement of the carrier in the first and second directions relative to the base unit.

10. The storage and retrieval system of claim 1, wherein the support surface of the carrier defines a portion of a movable floor of one of a storage room and a marine vessel.

11. A storage and retrieval system comprising:
a carrier defining a support surface configured to support a product stored by the storage and retrieval system, the carrier including a guide member configured to be rotated with respect to the support surface from a first position to a second position such that the carrier is configured to be moved in a first direction when the guide member is in the first position and the carrier is configured to be moved in a second direction when the guide member is in the second position;
a first base unit including a first track;
a second base unit including a second track; and
a third base unit including a third track;
wherein the second track is configured to be rotated from a first orientation where the second track is aligned with the first track such that the carrier is movable in the first direction from the second base unit to the first base unit, and wherein the second track is configured to be rotated from a second orientation where the second track is aligned with the third track such that the carrier is movable in the second direction from the second base unit to the third base unit.

12. The storage and retrieval system of claim 11, wherein the first, second, and third tracks each include a plurality of rollers.

13. The storage and retrieval system of claim 12, wherein the plurality of rollers of the first, second, and third tracks each form a portion of a friction drive configured to both receive the guide member and to move the carrier in the first and second directions.

14. The storage and retrieval system of claim 11, wherein the carrier includes a locking member, wherein the locking member is configured to be moved between a locked position and an unlocked position such that the locking member retains the guide member in one of the first and second positions when the locking member is in the locked position, and the guide member is configured to rotate with respect to the support surface when the locking member is in the unlocked position.

15. The storage and retrieval system of claim 14, wherein the carrier further includes a first recess and a second recess, wherein the locking member includes a pin member configured to be received in the first recess when the locking member is in the locked position to retain the guide member in the first position, and wherein the pin member is configured to be received in the second recess when the locking member is in the locked position to retain the guide member in the second position.

16. The storage and retrieval system of claim 15, wherein the first, second, and third base units each include an unlocking member, the unlocking members being configured to extend from the base unit from a first unlocking member position to a second unlocking member position to move the pin from the locked position to the unlocked position.

17. The storage and retrieval system of claim 16, wherein the first, second, and third base units are configured to be fixed with respect to a floor that supports the first, second, and third base units, and wherein when the unlocking member of the first base unit is configured to be in the second position at least a portion of the unlocking member is configured to be in one of the first and second recesses of the carrier to fix the location of the carrier with respect to the first base unit.

18. The storage and retrieval system of claim 11, wherein the first, second, and third base units each include a plurality of ball transfer units configured to facilitate movement of the carrier in the first and second directions with respect to the base unit.

19. The storage and retrieval system of claim 11, wherein the carrier includes a carrier plate, and wherein the guide member is interconnected to the carrier plate.

20. The storage and retrieval system of claim 11, further comprising a plurality of carriers each defining a support surface, wherein the support surfaces of the plurality of carriers define a movable floor of one of a storage room and a marine vessel.

21. The storage and retrieval system of claim 11, wherein the second track is a portion of a friction drive configured to move the carrier in the first and second directions, wherein the second track is inoperable to move the carrier in the first direction when the guide member is in the second position, and wherein the second track is inoperable to move the carrier in the second direction when the guide member is in the first position.

22. The storage and retrieval system of claim 21, wherein the second track is inoperable to move the carrier in the first direction when the second track is in the second orientation, and wherein the second track is inoperable to move the carrier in the second direction when the second track is in the first orientation.
